(19) United States
(12) Patent Application Publication
(10) Pub. No.: US 2013/0071574 A1
(43) Pub. Date: Mar. 21, 2013

(54) Vehicle Component Including Basalt and Method for Making Same

(71) Applicant: Midway Products Group, Inc., Monroe, MI (US)

(72) Inventors: Johnny H. Allison, Plymouth, MI (US); Randall T. Schott, Temperance, MI (US); Robert A. Longridge, Canton, MI (US); Daryl Adams, Novi, MI (US)

(73) Assignee: Midway Products Group, Inc., Monroe, MI (US)

(21) Appl. No.: 13/621,917

(22) Filed: Sep. 18, 2012

Related U.S. Application Data
(60) Provisional application No. 61/536,311, filed on Sep. 19, 2011.

(51) Int. Cl. B05D 1/02

(52) U.S. Cl. 427/427.4

(57) ABSTRACT

A vehicle component formed using a reinforcing mixture that includes a plurality of basalt fibers. According to one embodiment, the reinforced vehicle component could be formed by a method in which a vehicle component is provided for reinforcement, such as a vehicle panel that may be stamped from steel. Basalt fibers are mixed with a carrier that includes one or more of an epoxy or a glue. The mixture of basalt fibers and the carrier are applied to the vehicle panel. In one embodiment, for example, the mixture could be sprayed onto the vehicle panel for purposes of reinforcement.

### RELATED APPLICATIONS

The present application is related to and claims priority to U.S. Provisional Patent Application Ser. No. 61/536,311, filed on Sep. 19, 2011, entitled “Vehicle Component Including Basalt and Method for Making Same.” To the extent not included below, the subject matter disclosed in this application is hereby expressly incorporated into the present application in its entirety.

### BACKGROUND AND SUMMARY

A basalt fiber offers many favorable qualities. For example, a basalt fiber generally offers a very strong material high tensile strength (e.g., 3200 MPa), high softening temperature (e.g., 1200 degrees Celsius), operating temperature typically from −260 to 760 degrees Celsius, low elongation modulus (e.g, 89 GPa), density (e.g., 2.7 grams/cubic centimeter), high sound absorption coefficient (e.g., 0.95) and radiation proof lead equivalent (e.g., 0.0073 mm P b), high electrical resistance and basalt is recyclable. Basalt is stronger than steel, but is lighter with a weight about the same as aluminum. FIG. 1 illustrates an exploded view of an example strand of pultruded basalt fiber.

Basalt has several favorable qualities compared to carbon fiber
Basalt is much cheaper than carbon fiber
Basalt is stronger than E-glass, and as strong as and cheaper than S-glass.
Basalt has a very good tolerance to high and low temperature.
Higher electrical insulation value than E-glass.
Basalt is much more resistant to shattering than carbon. This leads to a much more forgiving failure mode.
Basalt does not conduct electricity. Basalt does not induce fields when exposed to high levels of RF energy, which means there is no issue of Faraday cage effect. Basalt can be used in high level RF fields without strange electrical issues happening to the structure.
Basalt is transparent to microwave energy. Basalt does not absorb microwave energy until it reaches around 800 F.
Basalt has high resistance to acid and alkali conditions

One focus of this application is to demonstrate how basalt fiber material can be used as reinforcement for steel panels, offer a built in roll cage system while building lighter and stronger vehicles. The basalt fiber offer extremely strong characteristics which can be harnessed and employed in the building of safer stronger production vehicles. It is planned on accomplishing this build of vehicles using basalt by reinforcing the existing panels on the inside with basalt fiber or the outside of the panel. The basalt material offers an outer reinforcement that can be strengthened by the existing panels with modifications.

The production vehicle can have a built in roll cage system of basalt material built in the panels, and up from the frame system. The basalt reinforced panels offer the build of modular structures for easy assembly of vehicle. The basalt material can have color mixed it the assemblies to offer colored panels. The basalt fiber may be mixed in with epoxy and or glue that adheres to metals and can also offer a class A surface. The resin basalt mixture can also be painted and repaired in much the same fashion as fiber glass.

According to one embodiment the disclosure provides a method of manufacturing a vehicle component. For example, the method may include the step of providing a vehicle panel Basalt fibers are mixed with a carrier, such as epoxy or glue. This mixture of basalt fibers and epoxy or glue is applied to the vehicle panel. For example, in some embodiments, the application could be done by spraying the mixture of basalt fibers and epoxy or glue to the vehicle panel. In some cases, the basalt fibers are chopped into segments that are mixed with a heat curing glue. For example, the basalt fibers are mixed with a heat curing glue at approximately 320° F. for approximately twenty minutes. This allows the vehicle panel to be dried at an ambient temperature. In some embodiments, a mixture of approximately 70 percent basalt fibers and 30 percent glue or epoxy by volume could be used. If it is desirable for the component to be colored, a color additive could be added to the glue or epoxy mixture. This could be used to reinforce a number of different areas in the vehicle, such as an inner surface or outer surface of a stamped panel. Embodiments are contemplated in which one or more corners of a roll cage could be reinforced using basalt fibers.

Additional features and advantages of the invention will become apparent to those skilled in the art upon consideration of the following detailed description of the illustrated embodiment exemplifying the best mode of carrying out the invention as presently perceived. It is intended that all such additional features and advantages be included within this description and be within the scope of the invention.

### BRIEF DESCRIPTION OF THE DRAWINGS

The present disclosure will be described hereafter with reference to the attached drawings which are given as non-limiting examples only, in which:

FIG. 1 is an exploded view of an example strand of pultruded basalt fiber;

FIG. 2 illustrates an example of conventional method of spray application of basalt fiber and resin;

FIGS. 3 and 4 provide examples of stamped panels reinforced with basalt according to one embodiment of the invention;

FIG. 5 provides an example roll cage assembly reinforced with basalt according to one embodiment of the invention;

FIG. 6 shows a joint where the basalt rods are joined according to one embodiment of the invention; and

FIGS. 7, 8 and 9 illustrate an example embodiment for testing the strength of a B pillar reinforced with basalt.

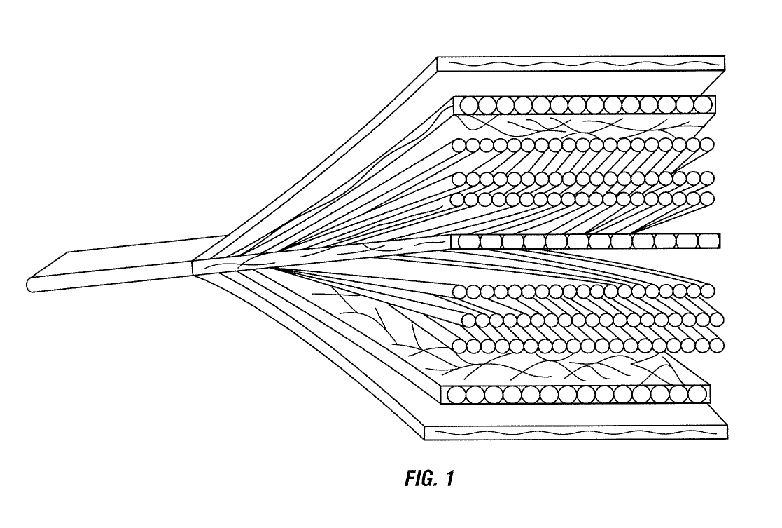

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

According to one embodiment a basalt material may be mixed with epoxy or glue to offer a strength reinforcement that is proportional to the mixture of the fiber with the carrier of epoxy or glue. Various embodiments are contemplated for applying the fiber to a stamped panel. The basalt material could be used in the same way as fiberglass and epoxy for build and repair. The application of a basalt fiber/epoxy mixture can be sprayed on in operation, which offers a rapid covering of a stamped panel. This is a primary candidate for operations requiring rapid production.

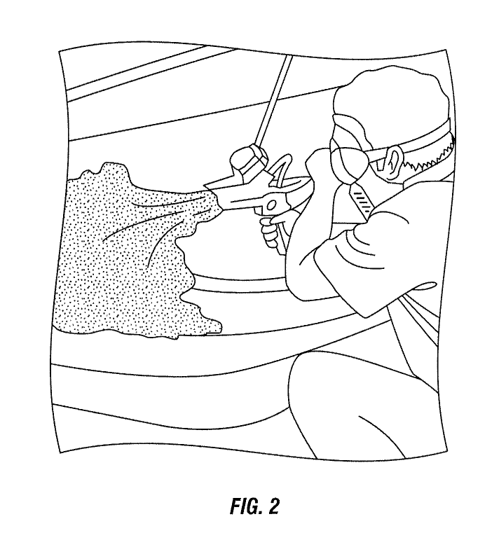

In one embodiment, chopped fiber may be added into heat curing glue. For example, glue or epoxy could be used in the production of an automotive panel. The use of a heat curing adhesive with the woven fiber of basalt could be performed by die cutting and attaching the fiber with epoxy or heat cured glue making stronger lighter panels. FIG. 2 provides an example spray application of basalt fiber and resin.

The basalt woven fiber could be die cut and placed into position and adhesively attached or epoxy attached. For example, in one embodiment, the basalt fiber could be mixed with a heat cured glue at 320 Degrees F. for 20 Min. The epoxy is the preferred method of adhesion, because it will dry in the ambient temperature and still be able to pass through the heat ovens without degrading.

In another embodiment, basalt fiber is mixed with glue that is rated to the level to hold metal together. This method works well but the parts must be clamped in place until the assembly passes through the paint oven and cures the glue. This is in some cases a costly process. In this process the glue becomes as strong as the metal it is attached to and the basalt fiber used in the mix of the glue 70% fiber long or short fiber per operation and 30% glue, or epoxy. This mix works well in the manufacture operation.

Basalt used the construction of automotive parts offers a lot of positive attributes to the process. The basalt can be attached to a stamped panel on the inside offering strength and being invisible to the customer. This will achieve far stronger panels that are lighter than steel. If the basalt is attached to the outside of the panel the epoxy can be developed into a class A, first surface panel offering strength and color can be added to the epoxy or glue. The basalt can be added to the inner and outer surface of stamped panel adding strength and with a minimum of support stamped steel.

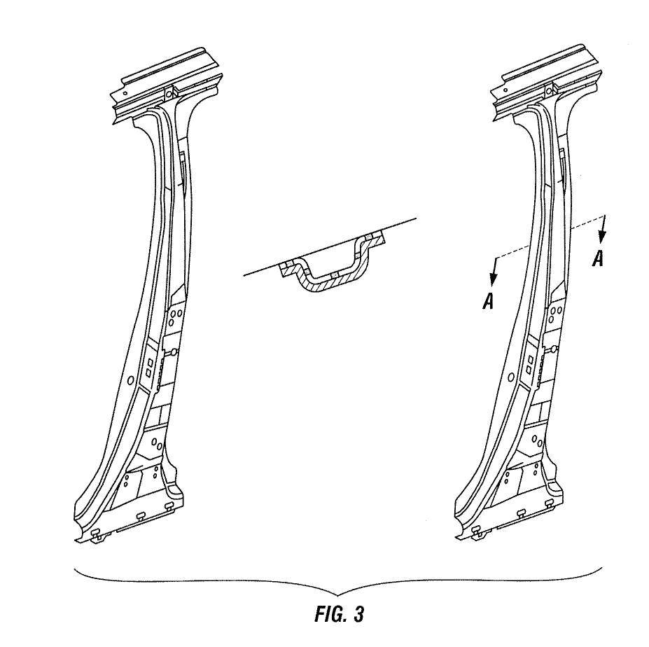

FIG. 3 shows an example of basalt fibers applied to the outside of a stamped panel. The basalt fiber placed on the outside of a stamped panel's offers strength, a class A surface and color can be added to the epoxy or glue. The basalt can be a mixed formula of basalt fiber and epoxy or glue sprayed on to the base stamping. Another option is to lay the woven fibers onto the stamped panel using epoxy or heating curing adhesive. The panel can be painted after the epoxy or glue is dried.

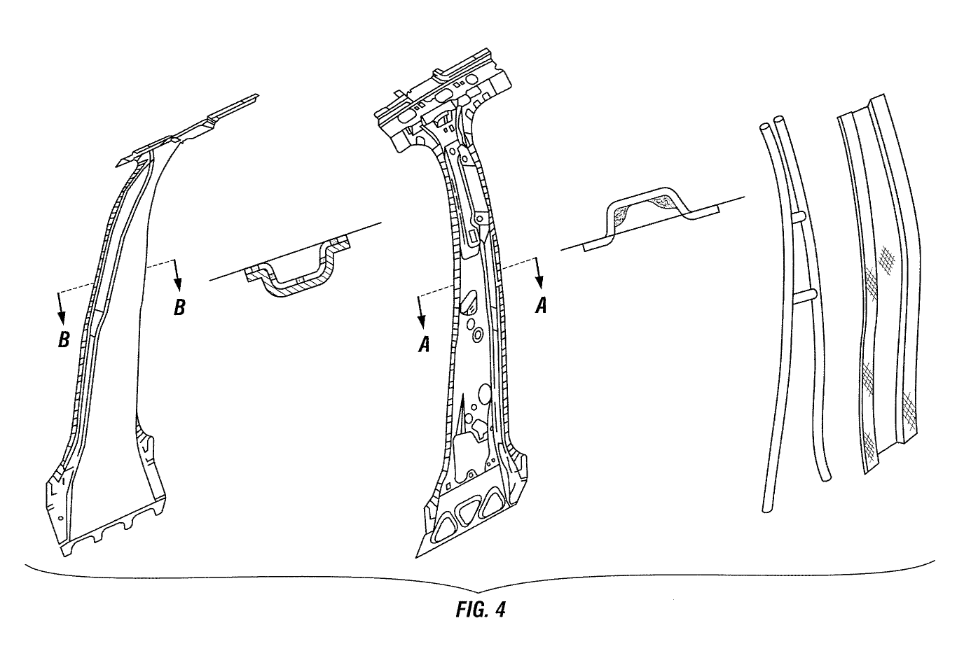

FIG. 4 shows a reinforcement of the steel stamped panel with the continuous fiber basalt. In this example, the basalt is placed in the corners of the “B” pillar as a mixture of continuous fiber and epoxy or glue. A second alternative is to use multiple layers of the basalt woven fibers, which would be placed in the contour of the stamped panel and pressed in place. In this operation, an anaerobic fermentation process would be used where the epoxy is injected into the die and the air vacuumed out for a quicker turnaround time.

A roll cage could be build according to one embodiment starting from the frame and using the stamped panels reinforced with basalt fiber. This process would build a complete roll cage system offering protection for the passengers without the sacrificing the design of the vehicle. There have been several joints designed to pull the roll cage together the joints will bring the basalt reinforcement together and be adhesively joined or glued. In the case of the top of the “B” pillar of the vehicle, according to one embodiment, there will be a joint that joins five support stampings together to offer a very strong joint in a key location. The other joints are corners to offer strength and lend to a modular build of the side frames and, roof and frame. This is a process that will eliminate several welding operations and lend to the modular construction of a vehicle.

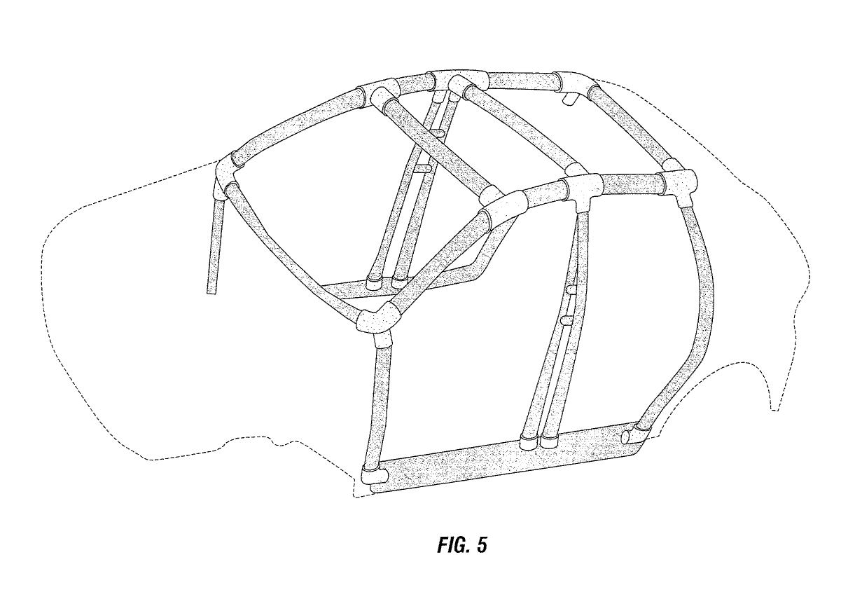

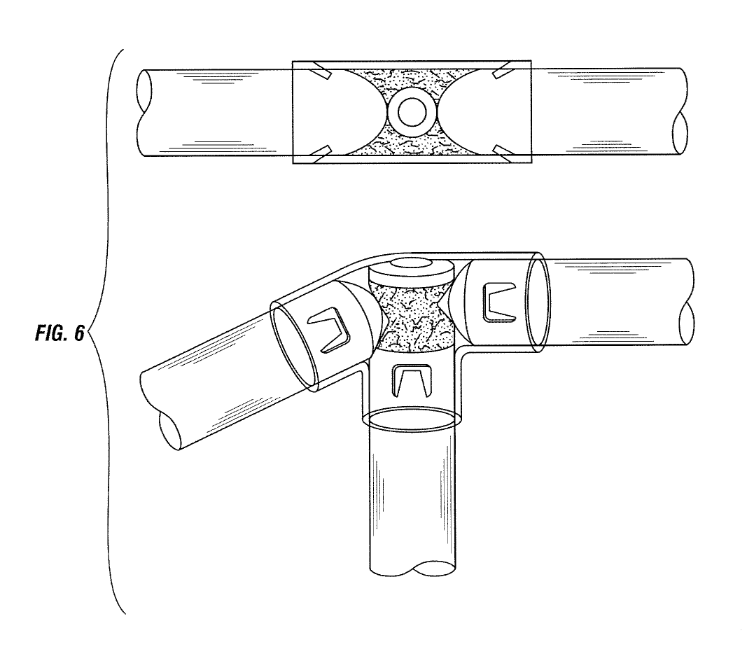

FIG. 5 shows a structured roll over cage that will be fastened to the panels. With this design, all of the panels come together into a joint at joints (See FIG. 6) and creating a built in roll cage in the production vehicle. This offers a stronger structure with little added weigh and parts. We are simply modifying the existing panels by adding the basalt for strength in manufacturing. The assembly of the panels can result into a modular construction with an easy assembly operation. The structure extends upward from the frame and across the roof and sides of the vehicle creating a roll cage to protect the inside in a very strong structure.

FIG. 6 shows an example joint where the basalt rods are joined. There are several possible joints to be designed in the roll cage assembly. The basalt rod or structure is placed into a joint sleeve. As the basalt rod or structure is placed into the outer joint assembly it passes a series of one way lock tabs. The purpose of the tabs is to provide a one way lock to hold the parts together until the adhesive takes effect. When all the basalt rods or structure are placed into the joint sleeves, there is epoxy or glue injected into the assembly to harden and make the assembly very strong. The rod or structure has a pointed end that fits into a valley in the other rods or structure. One purpose of this design is to make a solid attachment of the parts.

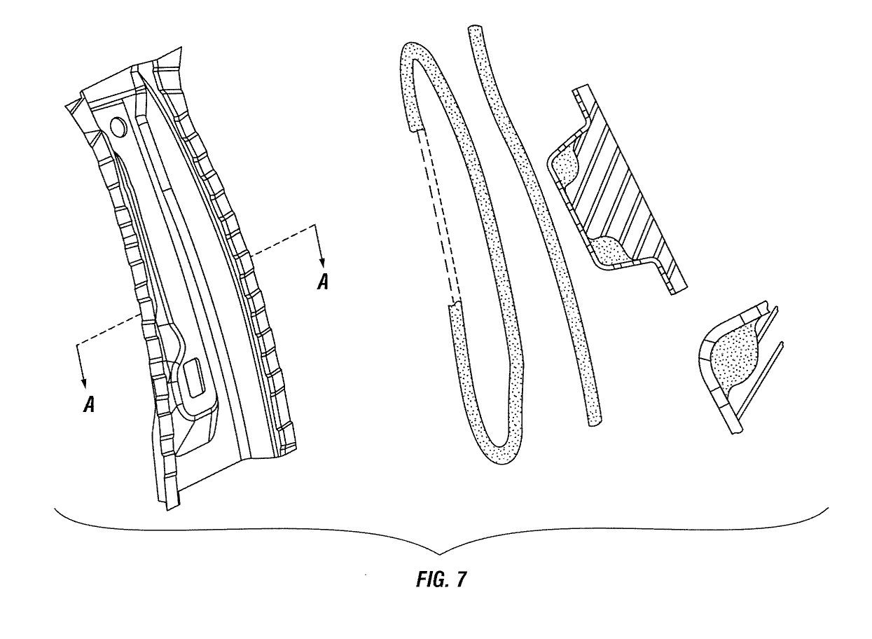

FIGS. 7, 8 and 9 show an example prototype for testing how to make a reinforced “B” pillar. The “B” pillar is a critical section that is cut out of the “B” pillar stamping. In this local area, the crush is most likely to occur in a roll over crash. For the test, this location has been isolated as our test area is the worst case. The B pillar is cut off at top from Line A and at the bottom Line B (1). The entire series of “B” pillar are all the same and laser cut to his exact position. By preparing the B pillar panels in this manner we have a common comparison to determine the materials to use and how much material to use to batch the Boron “B” Pillar in use today. This will give us common base to compare for strength.

In FIG. 7 is shown a method to determine the amount of basalt continuous fiber (2) to apply to the strengthening of the B pillar section (1). The target of continuous fiber estimated needed is based on a 1″ diameter of Basalt re-rod (3) for which we have test data on. (Stork Material Technology 25 mm Diameter average yield strength 0.2% psi=62,200 or 43161.2 n/cm̂2 and Average tensile Strength, psi=68,600 or 47,298.04 n/cm̂2). In using this data as a starting point, we are planning to line each side of the B pillar test panel (1) with the equal amount of 1″ diameter or basalt continuous fiber (2). The 1 “basalt fiber re rod (3) has a 140 continuous fibers (2) running parallel through it from end to end. When epoxy or glue is added to the fiber, the mixture becomes very strong and when attached to the B pillar test panel (1) it reinforces the panel many fold over per testing evaluation. By wrapping the basalt re rod around the B test pillar 140 times we have the equal amount of the basalt 1” re-rod (3) equal 4800 tex from 24 cakes this 115200 continuous fibers (2) coming together to make the reinforcement of the B pillar test panel (1) one layer on each side is shown a method to determine the amount of basalt continuous fiber (2) to apply to the strengthening of the B pillar section (1). The basalt continuous fiber (2) is placed in the corners of the B pillar test panel (1) and an internal mold (6) is built with cavities for the basalt continuous fiber (2) and layer basalt woven fiber (7). The basalt woven fiber (7) is laid over the basalt continuous fiber (2) with a mixture of epoxy or glue and the internal mold (6) forces out the excess epoxy or glue and forces the material hard against the inside walls of the B pillar test panel (1). There is an anaerobic process used to remove the air and accelerate the hardening of the epoxy or glue.

According to another embodiment, the basal woven fiber (7) is used much the same way as a fiberglass operation can be used. The difference being that it is many times stronger when finished. We are contemplating that this may replace a roof panel made from carbon fiber. The basalt fiber is in a close range to carbon fiber but less expensive and near the same strength and looks the same as carbon fiber. In the manufacture or molding of panels the anaerobic process is used with epoxy and glue as a hardening agent. A roof made of carbon fiber is dangerous and will not pass the roll over tests. Carbon fiber is glass filled and shatters when it reaches its breaking point. Basalt per strand is a rock fiber and breaks, but does not shatter. Basalt is close to the strength of carbon fiber and less expensive. Carbon fiber has a lengthy production process and on a mass production scale carbon fiber could the meet the demands. Basalt is the most abundant material around and can be manufactured with little loss. If you wanted to produce a ton of basalt fiber, you use one ton of basalt rock. There are no additives or losses. This is not the case of steel and carbon fiber.

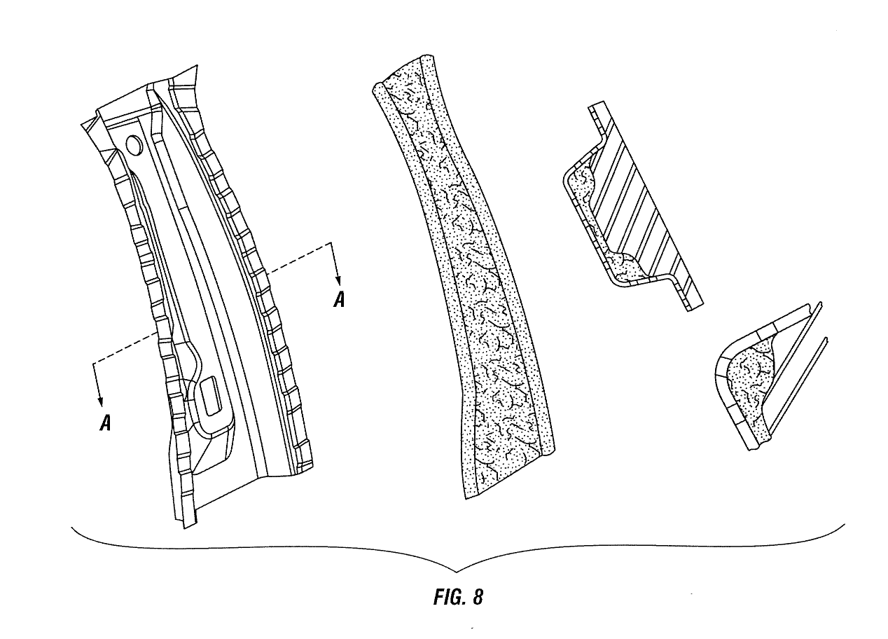

In FIG. 8 is shown a method to determine the amount of basalt chopped fiber (8) to apply to the strengthening of the B pillar section (1). The basalt chopped fiber (8) is sprayed onto the B pillar test panel (1). The basalt continuous fiber (2) is placed in the corners of the B pillar test panel (1) and an internal mold (6) is built with cavities for the basalt continuous fiber (2) and layer basalt woven fiber (7). The basalt chopped fiber (8) is sprayed over the basalt continuous fiber (2) with a mixture of epoxy or glue and the internal mold forces out the excess epoxy or glue and forces the material hardening against the inside walls of the B pillar test panel (1). There is an anaerobic process used to remove the air and excel the hardening of the epoxy or glue.

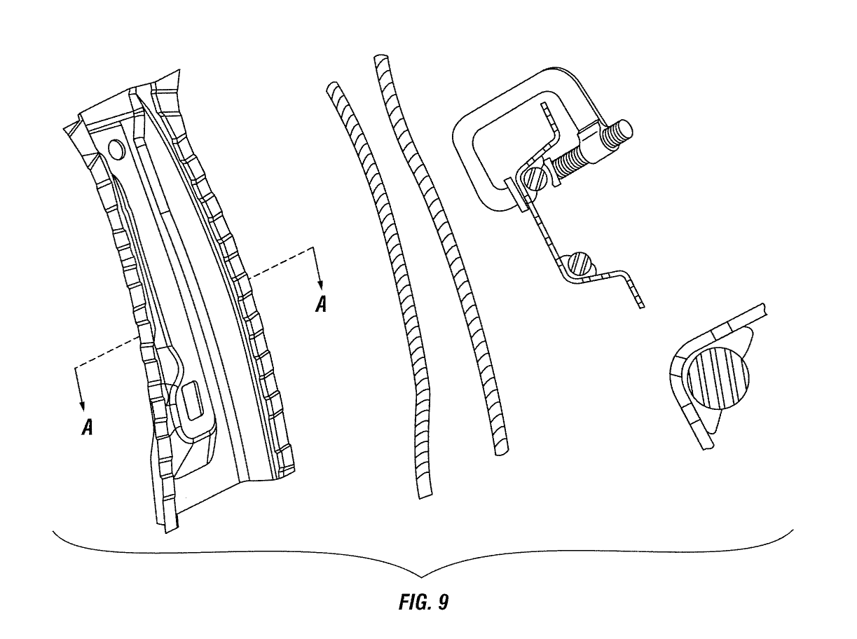

In FIG. 9 is shown a method of fastening the basalt re-rod (9) into the corners of the B pillar test panel (1). The re-rod (9) will be glued with epoxy or glue to the B pillar test section (1) till the time that it becomes attached to the B pillar test panel (1). We know the tensile strength of the re-rod from the Stork Test data. Because the 1″ diameter re-rod (3) cannot be bent we will have to test with lesser diameter re-rod samples. We are looking at possibly 12 mm, 8 mm or 6 mm for purposes of testing because we have re- rod and Stork test data on these sizes. This test is to determine what level of strength we need to compete with the market of (roll over test 4× the vehicle body weight). If we need to obtain more strength we can overlay the re-rod (9) with basalt woven fiber number of layer (7) or spray basalt chopped fiber (8) onto the assembly.

Basalt fiber has great strength can be attached to existing stamped panels or plastic panels. In this way we can bring a strong panel to the market. The attaching of the basalt offers an opportunity in the manufacturing industry. The basalt fiber if mixed with an adhesive can be used as a way of attaching panels and also building strength into the panels. In some cases this may require heating the adhesive until it cures. In other cases, the adhesive can be cured in ambient temperature. Whatever the attachment method chosen, the basalt fiber is mixed into the adhesive serves to strengthen the panels. The basalt fiber can be chopped into small fibers such as 13 micron to 3 mm long and mixed into the adhesive. The fiber can also be used as a continuous filament of the fiber that is placed axial into the corners of a panel offering strength.

The continuous strand fibers are somewhat awkward in the rapid assembly operation because of the time to place them into the proper place and cure them until hardened. This is an operation that we would have to move to an area that would pre mold up the reinforced panels ahead of the assembly operation with a reasonable time of set up. When the reinforcement panels are cured up, they are added to the assembly operation. The continuous fiber is placed into the desired position and then a die is placed into the area and holds the materials in place until the time they have cured. An example would be a hat section panel with the basalt placed into the corners. The next operation would be for a die would be placed in the hat section holding the continuous fiber in place and squeezing the excess epoxy or glue out. The die would be molded of a releasing agent to prevent the epoxy or glue from attaching to it as well. In this manner the continuous fiber and the epoxy or glue will attach itself to the hat section and when cured the hat section will be stronger.

The attachment of panels together with the use of adhesive is known in the industry. The adhesive has glass balls added to it to keep the panels a few microns apart and allow the adhesive to cure up without being squeezed out of the targeted area. By adding the basalt fibers into the adhesive, we are serving the same purpose but also adding the strength of the basalt fiber to joint. This would also eliminate the need for the glass balls to separate the panels. The adhesive company's advertise the glass balls off as a means of separating panels to eliminate the electrical effect between two dissimilar metals such as aluminum and steel. The basalt material does not conduct electrical current so it would be an excellent spacer and strengthener for the use in joining panels together. Basalt is not only strong but it has a resistance to electricity and can be used in the manufacture of housing and for electrical equipment such as modules.

In the making of a basalt panel with a class A surface we can pre mold sheets of bi axle fabric basalt with +45 degrees/−45 degree orientation, so tri axial fabric with 0 degree/+45 degree/−45 degree strands, and also 4 axis 0 degree, 90 degree +45/−45 degree in a pre-mold process in the shape needed. We can add a layer of fiber that is a layer of chopped strand mat, similar to a glass mat used for fixing boats. This mat can be fixed to a layer of woven fiber or sheet layers this will give a multiple layer assemble that is molded to one part. The construction will build up the laminate thickness quicker than you can with multiple layers of fabric. Using this process, we can mold panels that are strong and can have a class A surface. This can be used to make car panel like hoods fenders, truck cabs, and train cover panels.

The basalt fiber has a high temperature resistance and good light resistance. The basalt material in the woven type can very easily be adapted to vehicle interiors as fire resistant fabrics and as well as clothing. The clothing can be used for firefighters etc. To my knowledge, the automotive industry has not used basalt as a strengthening agent in the build of a vehicle. In the manufacture of basalt if you melt and pour basalt, it will form a glass if quickly cooled. Knowing this we can melt and pour basalt into a mold and using a gradual cooling process. If you cool it slow enough you will reform a basalt rock in the needed shape. In doing this operation we can transform the basalt material into another form as we need it. In using this process we can achieve many different shapes as in sand casting. If it was desired to form a panel with honeycomb reinforcement behind it the forming method would be much like a large waffle iron. This is in the case of a hood or door panel or other like panels.

Although the present disclosure has been described with reference to particular means, materials, and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A method of manufacturing a vehicle component, the method comprising the steps of:
providing a vehicle panel;
mixing basalt fibers with a carrier that includes one or more of an epoxy or a glue; and
applying the mixture of basalt fibers and epoxy or glue to the vehicle panel.

2. The method of claim 1, wherein the applying step is performed by spraying the mixture of basalt fibers and epoxy or glue to the vehicle panel.

3. The method of claim 1, wherein the basalt fibers are chopped into segments that are mixed with a heat curing glue.

4. The method of claim 3, further comprising the step of drying the vehicle panel at an ambient temperature.

5. The method of claim 4, wherein the basalt fibers are mixed with a heat curing glue at approximately 320° F. for approximately twenty minutes.

6. The method of claim 1, further comprising the step of temporarily clamping one or more vehicle components of an assembly together prior to the applying step, further comprising the step of passing the assembly through an oven to cure the glue.

7. The method of claim 1, wherein the mixing step is performed by using approximately 70 percent basalt fibers and 30 percent glue or epoxy by volume.

8. The method of claim 7, further comprising the step of adding a color additive to the glue or epoxy mixture.

9. The method of claim 1, wherein the vehicle panel is a stamped panel and the mixture is added to one of an inner or outer surface of the stamped panel.

10. The method of claim 1, wherein the mixture is applied in one or more corners of a B pillar of a vehicle.

11. A vehicle component formed by a process comprising the steps of:
providing a vehicle panel;
mixing basalt fibers with a carrier that includes one or more of an epoxy or a glue; and
applying the mixture of basalt fibers and epoxy or glue to the vehicle panel.

12. The method of claim 11, wherein the applying step is performed by spraying the mixture of basalt fibers and epoxy or glue to the vehicle panel.

13. The method of claim 11, wherein the basalt fibers are chopped into segments that are mixed with a heat curing glue.

14. The method of claim 13, further comprising the step of drying the vehicle panel at an ambient temperature.

15. The method of claim 14, wherein the basalt fibers are mixed with a heat curing glue at approximately 320° F. for approximately twenty minutes.

16. The method of claim 11, further comprising the step of temporarily clamping one or more vehicle components of an assembly together prior to the applying step, further comprising the step of passing the assembly through an oven to cure the glue.

17. The method of claim 11, wherein the mixing step is performed by using approximately 70 percent basalt fibers and 30 percent glue or epoxy by volume.

18. The method of claim 17, further comprising the step of adding a color additive to the glue or epoxy mixture.

19. The method of claim 11, wherein the vehicle panel is a stamped panel and the mixture is added to one of an inner or outer surface of the stamped panel.

20. The method of claim 11, wherein the mixture is applied in one or more corners of a B pillar of a vehicle.
